(19) United States
(12) Patent Application Publication
(10) Pub. No.: US 2025/0002633 A1
(43) Pub. Date: Jan. 2, 2025

(54) ISOCYANATE-EPOXY HYBRID FOAMS HAVING LOW BRITTLENESS AND IMPROVED ADHESION

(71) Applicant: BASF SE, Ludwigshafen am Rhein (DE)

(72) Inventors: Arne KLINKEBIEL, Lemfoerde (DE); Sonja SCHMIDT, Ludwigshafen (DE); Jürgen BOOS, Lemfoerde (DE)

(21) Appl. No.: 18/290,590

(22) PCT Filed: Jul. 14, 2022
(86) PCT No.: PCT/EP2022/069757

§ 371 Date: Jan. 19, 2024

(30) Foreign Application Priority Data
Jul. 22, 2021 (EP) 21187200.7

(51) Int. Cl. C08G 18/00; B32B 5/20; B32B 15/04; B32B 15/18; B32B 15/20; C08G 18/40; C08G 18/42; C08G 18/48; C08G 18/50; C08G 18/76; C08J 9/08

(52) U.S. Cl. CPC C08G 18/003; B32B 5/20; B32B 15/046; B32B 15/18; B32B 15/20; C08G 18/4018; C08G 18/4288; C08G 18/4833; C08G 18/5024; C08G 18/7671; C08J 9/08; B32B 2250/40; B32B 2266/0271; B32B 2266/0278; B32B 2307/72; C08G 2110/005; C08G 2110/0058; C08J 2203/02; C08J 2375/08

(57) ABSTRACT

Described herein is a process for producing an isocyanate-epoxy hybrid foam, in which polyisocyanate is mixed with at least two compounds having at least two isocyanate-reactive hydrogens, chemical and/or physical blowing agents, comprising formic acid and optionally auxiliaries and additives to give a reaction mixture, where the equivalents ratio of isocyanate groups in the polyisocyanate to epoxy groups in the compound having at least two epoxy groups is 1.2:1 to 500:1, and the reaction mixture is converted to the foam, where the compound having at least two isocyanate-reactive hydrogen atoms includes at least one polyesterol having a hydroxyl number of 195 to 400 and an average nominal functionality of 2 to 4 and at least one polyether polyol having a hydroxyl number of 40 to 80 and an average nominal functionality of 2.6 to 6.5.

The present invention relates to a process for producing an isocyanate-epoxy hybrid foam having a density of 15 to 60 g/L, in which polyisocyanate (a) is mixed with at least two compounds (b) having at least two isocyanate-reactive hydrogens, at least one compound having at least two epoxy groups and having an epoxy equivalent weight of 90 to 500 g/eq, (c), at least one catalyst (d) that accelerates the reaction of compound (b) having at least two isocyanate-reactive hydrogens and of compound (c) having epoxy groups with the polyisocyanates (a), chemical and/or physical blowing agents, comprising formic acid (e), and optionally auxiliaries and additives (f) to give a reaction mixture, where the equivalents ratio of isocyanate groups in the polyisocyanate (a) to epoxy groups in the compound (c) having at least two epoxy groups is 1.2:1 to 500:1, and the reaction mixture is converted to the foam, wherein the compound (b) having at least two isocyanate-reactive hydrogen atoms includes at least one polyesterol (b1) having a hydroxyl number of 195 to 400 and an average nominal functionality of 2 to 4 and at least one polyether polyol (b2) having a hydroxyl number of 40 to 80 and an average nominal functionality of 2.6 to 6.5. The present invention further relates to isocyanate-epoxy hybrid foams that have been obtained by such a process and sandwich elements comprising isocyanate-epoxy hybrid foams of the invention.

The production of foams from polyisocyanates and polyepoxides is described, for example, in U.S. Pat. Nos. 3,793,236, 4,129,695 and 3,242,108. It is also known that polyols can also be used as well as polyisocyanates and polyepoxides. This is described, for example, in U.S. Pat. No. 3,849,349. One advantage of these foams is their high flame resistance.

KR 102224864 describes an insulation material for liquefied gas tanks, which is obtained from a foaming mixture comprising a hexafunctional polyether polyol, an octafunctional polyether polyol, a trifunctional polyether polyol, an aromatic polyester polyol, isocyanate, blowing agent and bisphenol-based epoxide.

WO2004085509 discloses polyisocyanurate-epoxy foams with n-pentane as physical blowing agent.

US2013324626 discloses polyurethane sandwich elements and production thereof.

EP3059270 discloses thermally stable isocyanate/epoxy-based foams having high flame retardancy. Such foams are obtained by reacting isocyanate, epoxide, a catalyst having an isocyanate-reactive group and blowing agent to give the foam.

The more recent prior art describes the preferred production of such isocyanate-epoxy hybrid foams from reaction mixtures of polyisocyanates and polyepoxides via an intermediate stage, comprising partly trimerized isocyanurate groups (=intermediate) that are stabilized with the aid of stoppers. In this case, the high-temperature-stable foams are obtained by conversion of reaction mixtures of polyisocyanates, polyepoxides, catalysts and stoppers to a storage-stable intermediate of relatively high viscosity (‘pre-trimerization’) and the conversion of this intermediate of relatively high viscosity by addition of blowing agents and a catalyst that spontaneously accelerates the isocyanate/epoxide reaction to give the ultimate foamed final state which is no longer meltable. Such isocyanate-epoxy hybrid foams are described, for example, in EP3259295. For instance, EP 3259295 discloses that the epoxide-isocyanate foams (EPIC foams) can be produced without stoppers as well and nevertheless have high flame retardancy.

The quality of the foams thus produced can be crucially improved according to WO 2012/80185 A1 and WO 2012/150201 A1 if particular blowing agents are used for the production of the EPIC foams. The EPIC foam is likewise produced according to the teaching of these documents preferably via the conversion of the reactants in the presence of a stabilizer that acts as stopper.

A disadvantage of these isocyanate-epoxy hybrid foams, especially those that are produced by the two-stage process, is an unsatisfactory conversion of the isocyanate (NCO) groups. However, free (unreacted) isocyanate groups in the foam (called “residual NCO”) can lead to unwanted aging processes, such as adhesion problems and deterioration of mechanical properties, e.g. embrittlement.

According to EP3259294, the conversion of the NCO groups was improved by the use of carbodiimide structures (<10% by weight). EP3259293 discloses the production of such isocyanate-epoxy hybrid foams based on isocyanates and polyepoxides in a one-stage process without subsequent heat treatment. The foam is produced with an incorporable catalyst that accelerates isocyanate-epoxide reaction. Nevertheless, these foams have mechanical properties that are still in need of improvement, especially brittleness that is in need of improvement and adhesion to metals that is in need of improvement, which is of relevance especially in the production of sandwich elements.

The production of composite elements from metallic outer layers in particular and a core composed of isocyanate-based foams, frequently also referred to as sandwich elements, can be effected batchwise or continuously, for example on continuously operating double belt systems. Continuous production on double belt systems is currently practiced on a large scale. In addition to sandwich elements for refrigerated warehouse insulation, elements for forming façades of a very wide variety of buildings are becoming ever more important.

It was therefore an object of the present invention to improve the mechanical properties of the isocyanate-epoxy foams, especially brittleness, and the adhesion thereof to metals. It has now been found that, surprisingly, the combined selection of particular polyisocyanates and of the blowing agent, and the use of polyols of high and low molecular weight, makes it possible to obtain foams having brittleness and adhesion to metal outer layers which is significantly superior to those of the foams based on isocyanate and epoxy that have been produced according to the prior art.

The object of the invention is therefore achieved by an isocyanate-epoxy hybrid foam having a density of 15 to 60 g/L, producible by a process in which polyisocyanate (a) is mixed with at least two compounds (b) having at least two isocyanate-reactive hydrogens, at least one compound (c) having at least two epoxy groups and having an epoxy equivalent weight of 90 to 500 g/eq, at least one catalyst (d) that accelerates the reaction of compound (b) having at least two isocyanate-reactive hydrogens and of compound (c) having epoxy groups with the polyisocyanates (a), chemical and/or physical blowing agents, comprising formic acid (e), and optionally auxiliaries and additives (f) to give a reaction mixture, where the equivalents ratio of isocyanate groups to epoxy groups is 1.2:1 to 500:1, and the reaction mixture is converted to the isocyanate-epoxy hybrid foam, wherein the compound (b) having at least two isocyanate-reactive hydrogen atoms includes at least one polyesterol (b1) having a hydroxyl number of 195 to 400 and an average nominal functionality of 2 to 4 and at least one polyether polyol (b2) having a hydroxyl number of 40 to 80 and an average nominal functionality of 2.6 to 6.5.

The invention further provides a process for producing isocyanate-epoxy hybrid foams of the invention and for the use thereof in the production of composite elements composed of outer layers and a core of isocyanate-epoxy hybrid foam, called sandwich elements. Outer layers used are preferably metal outer layers, such as steel, aluminum or copper sheets.

The process for producing sandwich elements can be effected continuously or discontinuously. A discontinuous mode of operation can be an option, for example, in startup operations for the double belt and in the case of composite elements produced by means of batchwise presses. Continuous employment is effected in the case of double belt systems being used. In the double belt process, the reaction mixture is produced, for example, by high- or low-pressure technology and frequently applied to the lower outer layer by means of oscillating or fixed applicator rakes. The upper outer layer is then applied to the reaction mixture as it reacts to completion. This is followed by the final curing to give the foam, preferably still in the double belt. Such processes are known and are described, for example, in the Kunststoffhandbuch [Plastics Handbook], volume 7, “Polyurethane” [Polyurethanes] Carl-Hanser-Verlag Munich, 3rd edition, 1993, chapters 4.2.2, 6.2.2 and 6.2.3.

Outer layers used may be flexible or rigid, preferably rigid, outer layers such as gypsum plasterboard, glass tiles, aluminum foils, aluminum sheets, copper sheets or steel sheets, preferably aluminum foils, aluminum sheets or steel sheets, more preferably steel sheets. The outer layers here may also be coated, for example with a conventional surface coating. The outer layers may be coated or uncoated. The outer layers may be pretreated, for example by corona treatment, arc treatment, plasma treatment or other customary measures.

In the double belt process, the outer layer is transported preferably at a constant speed of 1 to 60 m/min, preferably 2 to 50 m/min, more preferably 2.5 to 30 m/min and especially 2.5 to 20 m/min. The outer layer, at least from the application of the foam system, is in an essentially horizontal position.

Prior to the application of the reaction mixture to the lower outer layer, in the process of the invention, the outer layer(s) is/are preferably unrolled from a roll, optionally profiled, optionally heated, optionally pretreated, in order to increase foamability, and optionally coated with adhesion promoter. In a continuous double belt process, the reaction mixture is preferably cured in the double belt and ultimately cut to the desired length.

Useful polyisocyanates (a) are the organic, aliphatic, cycloaliphatic, araliphatic, and preferably aromatic polyfunctional isocyanates that are known per se. Such polyfunctional isocyanates are known per se or can be prepared by methods known per se. The polyfunctional isocyanates may in particular also be used in the form of mixtures, so that component (a) in this case comprises different polyfunctional isocyanates. Polyfunctional isocyanates useful as polyisocyanate have two isocyanate groups per molecule (these are hereinafter referred to as diisocyanates) or more than two.

These include, in particular: alkylene diisocyanates having from 4 to 12 carbon atoms in the alkylene radical, e.g. dodecane 1,12-diisocyanate, 2-ethyltetramethylene 1,4,2-diisocyanate methylpentamethylene 1,5-diisocyanate, tetramethylene 1,4-diisocyanate and preferably hexamethylene 1,6-diisocyanate; cycloaliphatic diisocyanates such as cyclohexane 1,3- and 1,4-diisocyanate and also any mixtures of these isomers, 1-isocyanato-3,3,5-trimethyl-5-isocyanatomethylcyclohexane (IPDI), hexahydrotolylene 2,4- and 2,6-diisocyanate and also the corresponding isomer mixtures, dicyclohexylmethane 4,4′-, 2,2′- and 2,4′-diisocyanate and also the corresponding isomer mixtures, and preferably aromatic polyisocyanates such as tolylene 2,4- and 2,6-diisocyanate and the corresponding isomer mixtures, diphenylmethane 4,4′-, 2,4′- and 2,2′-diisocyanates and the corresponding isomer mixtures, mixtures of diphenylmethane 4,4′- and 2,4′-diisocyanates, polyphenylpolymethylene polyisocyanates, mixtures of diphenylmethane 4,4′-, 2,4′- and 2,2′-diisocyanates and polyphenylpolymethylene polyisocyanates (crude MDI) and mixtures of crude MDI and tolylene diisocyanates.

Particularly suitable are diphenylmethane 2,2′-, 2,4′- and/or 4,4′-diisocyanate (MDI), naphthylene 1,5-diisocyanate (NDI), tolylene 2,4- and/or 2,6-diisocyanate (TDI), dimethyldiphenyl 3,3′-diisocyanate, diphenylethane 1,2-diisocyanate and/or p-phenylene diisocyanate (PPDI), tri-, tetra-, penta-, hexa-, hepta- and/or octamethylene diisocyanate, 2-methylpentamethylene 1,5-diisocyanate, 2-ethylbutylene 1,4-diisocyanate, pentamethylene 1,5-diisocyanate, butylene 1,4-diisocyanate, 1-isocyanato-3,3,5-trimethyl-5-isocyanatomethylcyclohexane (isophorone diisocyanate, IPDI), 1,4- and/or 1,3-bis(isocyanatomethyl)cyclohexane (HXDI), cyclohexane 1,4-diisocyanate, 1-methylcyclohexane 2,4- and/or 2,6-diisocyanate and dicyclohexylmethane 4,4′-, 2,4′- and/or 2,2′-diisocyanate.

Modified polyisocyanates are frequently also used, i.e. products that are obtained by chemical reaction of polyisocyanates and have at least two reactive isocyanate groups per molecule.

Particular mention may be made of polyisocyanates containing ester, urea, biuret, allophanate, carbodiimide, isocyanurate, uretdione, carbamate and/or urethane groups, frequently also together with unreacted polyisocyanates.

The polyisocyanates of component (a) more preferably comprise 2,2′-MDI or 2,4′-MDI or 4,4′-MDI (also referred to as monomeric diphenylmethane or MMDI) or oligomeric MDI, which consists of higher polycyclic homologs of MDI that have at least 3 aromatic rings and a functionality of at least 3, or mixtures of two or three of the aforementioned diphenylmethane diisocyanates, or crude MDI, which is obtained in the preparation of MDI, or preferably mixtures of at least one oligomer of MDI and at least one of the abovementioned low molecular weight MDI derivatives 2,2′-MDI, 2,4′-MDI or 4,4′-MDI (also referred to as polymeric MDI). The isomers and homologs of MDI are typically obtained by distillation of crude MDI.

Polymeric MDI preferably comprises, as well as bicyclic MDI, one or more polycyclic condensation products of MDI having a functionality of more than 2, in particular 3 or 4 or 5. Polymeric MDI is known and is frequently referred to as polyphenylpolymethylene polyisocyanate.

The average functionality of a polyisocyanate comprising polymeric MDI can vary within a range from about 2.2 to about 4, in particular from 2.4 to 3.8 and in particular from 2.6 to 3.0. Such a mixture of MDI-based polyfunctional isocyanates having different functionalities is, in particular, the crude MDI obtained as intermediate in the preparation of MDI.

Polyfunctional isocyanates or mixtures of a plurality of polyfunctional isocyanates based on MDI are known and are marketed, for example, by BASF Polyurethanes GmbH under the name Lupranat® M20 or Lupranat® M50.

Component (a) preferably comprises at least 70% by weight, more preferably at least 90% by weight, and in particular 100% by weight, based on the total weight of component (a), of one or more isocyanates selected from the group consisting of 2,2′-MDI, 2,4′-MDI, 4,4′-MDI, and MDI oligomers. The content of oligomeric MDI is here preferably at least 20% by weight, more preferably from more than 30% by weight to less than 80% by weight, based on the total weight of component (a).

Organic compounds used as compound (b) having at least two isocyanate-reactive hydrogen atoms may be any of those that are typically used in the production of polyurethanes. Inventive compounds (b) comprise at least one polyesterol (b1) having a hydroxyl number of 195 to 400 mg KOH/g, preferably 200 to 300 mg KOH/g, and an average nominal functionality of 2 to 4, and at least one polyether polyol (b2) having a hydroxyl number of 40 to 80 mg KOH/g, preferably 50 to 70 mg KOH/g, and an average nominal functionality of 2.6 to 6.5, preferably 3 to 4.5. In the context of the invention, an average nominal functionality is understood to mean the averaged functionality of the starter compounds. Any decrease in functionality in the production of the polyols (b), especially the polyetherol polyols (b2), as a result of side reactions in the production is neglected.

Moreover, component (b) may comprise chain extenders and/or crosslinkers (b3), and also further compounds having at least two isocyanate-reactive hydrogen atoms that are commonly used in polyurethane chemistry and are not covered by the definition of compounds (b1) to (b3). Such further compounds having isocyanate-reactive hydrogen atoms are known and are described, for example, in the Kunststoffhandbuch, volume 7, “Polyurethane” Carl-Hanser-Verlag Munich, 3rd edition, 1993, chapter 3.1 or 6.1.1.

Component (b) preferably includes, in addition to components (b1) and (b2), less than 20% by weight, more preferably less than 10% by weight, based in each case on the total weight of component (b), of further compounds having at least two hydrogen atoms reactive toward isocyanate groups, and in particular no such further compounds.

The proportion by weight of the polyesterol (b1) in the total weight of polyesterol (b1) and polyetherol (b2) is preferably 40% to 80% by weight, more preferably 50% to 75% by weight and especially 60% to 70% by weight.

Suitable polyester polyols (b1) can preferably be prepared from aromatic dicarboxylic acids, or mixtures of aromatic and aliphatic dicarboxylic acids, particularly preferably exclusively aromatic dicarboxylic acids, and polyhydric alcohols. Instead of the free dicarboxylic acids it is also possible to use the corresponding dicarboxylic acid derivatives, for example dicarboxylic esters of alcohols having 1 to 4 carbon atoms or dicarboxylic anhydrides.

Aromatic dicarboxylic acids or aromatic dicarboxylic acid derivatives used are preferably phthalic acid, phthalic anhydride, terephthalic acid and/or isophthalic acid, in a mixture or alone, more preferably phthalic acid, phthalic anhydride, terephthalic acid or mixtures of at least 2 of these acids. Particular preference is given to using terephthalic acid or dimethyl terephthalate, especially terephthalic acid. Aliphatic dicarboxylic acids can be used in a minor amount in a mixture with aromatic dicarboxylic acids. Examples of aliphatic dicarboxylic acids are succinic acid, glutaric acid, adipic acid, suberic acid, azelaic acid, sebacic acid, decanedicarboxylic acid, maleic acid and fumaric acid. Preferably, the proportion of the at least difunctional aromatic acid is at least 20% by weight, based on the total weight of the acid component and the alcohol component.

Examples of polyhydric alcohols are: ethanediol, diethylene glycol, propane-1,2-diol and -1,3-diol, dipropylene glycol, butane-1,4-diol, pentane-1,5-diol, hexane-1,6-diol, decane-1,10-diol, glycerol, trimethylolpropane, and pentaerythritol, and alkoxylates thereof. Preference is given to using ethylene glycol, diethylene glycol, propylene glycol, glycerol, trimethylolpropane or alkoxylates thereof or mixtures of at least two of the polyols mentioned.

In a specific embodiment of the invention, another polyhydric alcohol used is a polyether polyol which is a reaction product of glycerol and/or trimethylolpropane with ethylene oxide and/or propylene oxide, preferably ethylene oxide, where the OH number of the polyether alcohol is in the range from 500 to 750 mg KOH/g. This results in improved storage stability of the component (b1).

The polyester polyols (b1) are produced using not only the aromatic dicarboxylic acids or derivatives thereof and the polyhydric alcohols but preferably also at least one fatty acid or fatty acid derivative, preferably a fatty acid.

The fatty acids may comprise hydroxyl groups. In addition, the fatty acids may comprise double bonds.

In one embodiment of the invention, the fatty acid preferably does not comprise any hydroxyl groups.

The average fatty acid content of component (b1) is preferably greater than 1% by weight, more preferably greater than 2.5% by weight, more preferably greater than 4% by weight and especially preferably greater than 5% by weight, based on the weight of component (b1). The average fatty acid content of component (b1) is preferably less than 30% by weight, more preferably less than 20% by weight, based on the total weight of component (b3).

The fatty acid or fatty acid derivative is preferably a fatty acid or fatty acid derivative based on renewable raw materials, selected from the group consisting of castor oil, polyhydroxy fatty acids, ricinoleic acid, hydroxy-modified oils, grapeseed oil, black cumin oil, pumpkin seed oil, borage seed oil, soybean oil, wheatgerm oil, rapeseed oil, sunflower seed oil, peanut oil, apricot kernel oil, pistachio nut oil, almond oil, olive oil, macadamia nut oil, avocado oil, sea buckthorn oil, sesame oil, hemp oil, hazelnut oil, evening primrose oil, wild rose oil, safflower oil, walnut oil, hydroxy-modified fatty acids and fatty acid esters based on myristoleic acid, palmitoleic acid, oleic acid, vaccenic acid, petroselic acid, gadoleic acid, erucic acid, nervonic acid, linoleic acid, linolenic acid, stearidonic acid, arachidonic acid, timnodonic acid, clupanodonic acid and cervonic acid.

The fatty acid used is more preferably oleic acid.

The polyester polyols (b1) may be prepared by polycondensing the aliphatic and aromatic polycarboxylic acids and/or derivatives and polyhydric alcohols without catalyst or preferably in the presence of esterification catalysts, advantageously in an atmosphere of inert gas such as nitrogen, in the melt at temperatures of 150 to 280° C., preferably 180 to 260° C., optionally under reduced pressure, down to the desired acid number which is advantageously less than 10, preferably less than 2. In a preferred embodiment, the esterification mixture undergoes polycondensation at the abovementioned temperatures down to a hydroxyl number of 400 to 195, preferably 350 to 200, under standard pressure and then under a pressure of less than 500 mbar, preferably 40 to 400 mbar. Examples of suitable esterification catalysts are iron, cadmium, cobalt, lead, zinc, antimony, magnesium, titanium, and tin catalysts in the form of metals, metal oxides or metal salts. The polycondensation can, however, also be carried out in the liquid phase in the presence of diluents and/or entraining agents, for example benzene, toluene, xylene or chlorobenzene, for azeotropic removal by distillation of the water of condensation.

The polyester polyols (b1) are produced by polycondensing the polycarboxylic acids and/or derivatives and polyhydric alcohols advantageously in a molar ratio of 1:1 to 2.3, preferably 1:1.05 to 2.2 and more preferably 1:1.1 to 2.1.

The polyester polyol (b1) preferably has a number-weighted average functionality of greater than or equal to 2, preferably of greater than 2, more preferably of greater than 2.2 and in particular of greater than 2.3, which leads to a higher crosslinking density of the polyurethane produced therewith and hence to better mechanical properties of the polyurethane foam. More preferably, the number-average functionality of the polyester polyol (b1) is less than 4, especially less than 3.

The polyester polyols (b1) obtained generally have a number-average molecular weight of 250 to 1200 g/mol, preferably 300 to 1000 g/mol and in particular 400 to 700 g/mol.

The polyether alcohols (b2) are typically produced by addition of alkylene oxides onto H-functional starter substances. This process is common knowledge and is customary for the production of such products.

Starter substances used may be alcohols or amines. Amines used may be aliphatic amines, such as ethylenediamine. In another embodiment of the invention, it is possible to use aromatic amines, especially tolylenediamine (TDA) or mixtures of diphenylmethanediamine and polyphenylenepolymethylenepolyamines. In a particularly preferred embodiment of the invention, component b) comprises polyether alcohols based on aliphatic amines, especially ethylenediamine.

For production of the polyether alcohols (b1), preferred H-functional starter substances are thus polyfunctional alcohols.

As well as amines, it is also possible to use alcohols as starter molecules. Examples of these are glycols, such as ethylene glycol or propylene glycol, glycerol, trimethylolpropane, pentaerythritol, and sugar alcohols, such as sucrose or sorbitol, for example as mixtures of different alcohols with one another. In particular, the solid starter substances such as sucrose and sorbitol are frequently mixed with liquid starter substances such as glycols or glycerol. The functionality of the starter substances chosen is a number-average functionality.

In a particularly preferred embodiment, the polyether (b2) used is exclusively an amine-started polyether.

Alkylene oxides used are preferably ethylene oxide, propylene oxide or mixtures of these compounds. Particular preference is given to the use of pure propylene oxide or mixtures of ethylene oxide and propylene oxide, with addition of ethylene oxide toward the end of the reaction such that ethylene oxide end groups having primary hydroxyl groups are obtained. In this case, preferably at least 50% by weight, more preferably at least 70% by weight and especially at least 80% by weight of propylene oxide is used, based on the total weight of propylene oxide and ethylene oxide.

The alkylene oxides are preferably added onto the starter substance in the presence of catalysts. Catalysts used are usually basic compounds, where the oxides and especially the hydroxides of alkali metals or alkaline earth metals have the greatest industrial significance. Potassium hydroxide is usually used as catalyst.

In one embodiment of the invention, amines are used as catalysts for production of the polyether alcohols (b2). These are preferably amines having at least one tertiary amino group, imidazole, guanidines or derivatives thereof. These aminic catalysts preferably have at least one group reactive with alkylene oxide, for example a primary or secondary amine group or, more preferably, a hydroxyl group.

Component c) comprising epoxy groups comprises any organic compounds having at least two epoxy groups, such as aliphatic, cycloaliphatic, aromatic and/or heterocyclic compounds, where component c) comprising epoxy groups has an epoxy equivalent weight of 90 to 500 g/eq. The preferred epoxides suitable as component c) have 2 to 4 and more preferably 2 epoxy groups per molecule and an epoxy equivalent weight of preferably 95 to 400 g/eq, more preferably 140 to 220 g/eq.

Suitable polyepoxides are, for example, polyglycidyl ethers of polyhydric phenols, for example of catechol, resorcinol, hydroquinone, 4,4′-dihydroxydiphenylpropane (bisphenol A), of 4,4′-dihydroxy-3,3′-dimethyldiphenylmethane, of 4,4′-dihydroxydiphenylmethane (bisphenol F), 4,4′-dihydroxydiphenylcyclohexane, of 4,4′-dihydroxy-3,3′-dimethyldiphenylpropane, of 4,4′-dihydroxydiphenyl, of 4,4′-dihydroxydiphenylsulfone S), (bisphenol of tris(4-hydroxyphenyl) methane, the chlorination and bromination products of the aforementioned diphenols, of novolaks (i.e. of reaction products of mono- or polyhydric phenols and/or cresols with aldehydes, especially formaldehyde, in the presence of acidic catalysts in an equivalents ratio of less than 1:1), of diphenols that have been obtained by esterification of 2 mol of the sodium salt of an aromatic oxycarboxylic acid with one mole of a dihaloalkane or dihalodialkyl ester (cf. British patent 1 017 612), or of polyphenols that have been obtained by condensation of phenols and long-chain haloparaffins comprising at least two halogen atoms (cf. GB patent 1 024 288). The following should also be mentioned: polyepoxy compounds based on aromatic amines and epichlorohydrin, e.g. N-di(2,3-epoxypropyl) aniline, N,N′-dimethyl-N,N′-diepoxypropyl-4,4′-diaminodiphenylmethane, N,N-diepoxypropyl-4-amino-phenyl glycidyl ether (cf. GB patents 772 830 and 816 923).

The following are also useful: glycidyl esters of polyfunctional aromatic, aliphatic and cycloaliphatic carboxylic acids, for example diglycidyl phthalate, diglycidyl isophthalate, diglycidyl terephthalate, diglycidyl adipate and glycidyl esters of reaction products of 1 mol of an aromatic or cycloaliphatic dicarboxylic anhydride and ½ mol of a diol or 1/n mol of a polyol having n hydroxyl groups or diglycidyl hexahydrophthalate, which may optionally be substituted by methyl groups.

Glycidyl ethers of polyhydric alcohols, for example of butane-1,4-diol (Araldite® DY-D, Huntsman), butene-1,4-diol, glycerol, trimethylolpropane (Araldite® DY-T/CH, Huntsman), pentaerythritol and polyethylene glycol may likewise be used. Of further interest are triglycidyl isocyanurate, N,N′-diepoxypropyloxyamide, polyglycidyl thioethers of polyfunctional thiols, for example of bismercaptomethylbenzene, diglycidyltrimethylenetrisulfone, polyglycidyl ethers based on hydantoins.

Finally, it is also possible to use epoxidation products of polyunsaturated compounds, such as vegetable oils and conversion products thereof. Epoxidation products of di- and polyolefins, such as butadiene, vinylcyclohexane, 1,5-cyclooctadiene, 1,5,9-cyclododecatriene, polymers and copolymers still comprising epoxidizable double bonds, for example based on polybutadiene, polyisoprene, butadiene-styrene copolymers, divinylbenzene, dicyclopentadiene, unsaturated polyesters, and also epoxidation products of olefins that are obtainable by Diels-Alder addition and then converted by epoxidation with per compound to polyepoxides, or of compounds comprising two cyclopentene or cyclohexene rings bound via bridgehead atoms or bridgehead atom groups, may likewise be used.

In addition, it is also possible to use polymers of unsaturated monoepoxides, for example of glycidyl methacrylate or allyl glycidyl ether.

Preference is given in accordance with the invention to using the following polyepoxy compounds or mixtures thereof as component (c):
polyglycidyl ethers of polyhydric phenols, especially of bisphenol A (Araldit® GY250, Huntsman; Ruetapox® 0162, Bakelite AG; Epikote® Resin 162, Hexion Specialty Chemicals GmbH; Eurepox 710, Brenntag GmbH; Araldit® GY250, Hunstman, D.E.R.™ 332, The Dow Chemical Company; Epilox® A 18-00, LEUNA-Harze GmbH) or Bisphenol F (4,4′-dihydroxydiphenylmethane, Araldit® GY281, Huntsman; Epilox® F 16-01, LEUNA-Harze GmbH; Epilox® F 17-00, LEUNA-Harze GmbH), polyepoxy compounds based on aromatic amines, especially bis(N-epoxypropyl) aniline, N, N′-dimethyl-N, N′-diepoxypropyl-4,4′-diaminodiphenylmethane and N, N-diepoxypropyl-4-aminophenyl glycidyl ether; polyglycidyl esters of cycloaliphatic dicarboxylic acids, especially diglycidyl hexahydrophthalate and polyepoxides formed from the reaction product of n moles of hexahydrophthalic anhydride and 1 mol of a polyol having n hydroxyl groups (n=integer of 2-6), especially 3 mol of hexahydrophthalic anhydride and one mole of 1,1,1-trimethylolpropane; 3,4-epoxycyclohexylmethane 3,4-epoxycyclohexanecarboxylate.

Polyglycidyl ethers of bisphenol A and bisphenol F and of novolaks or mixtures of two or more of these compounds are very particularly preferred, especially polyglycidyl ethers of bisphenol F.

Liquid polyepoxides or low-viscosity diepoxides, such as bis(N-epoxypropyl) aniline or vinylcyclohexane diepoxide, may in particular cases further lower the viscosity of already liquid polyepoxides or convert solid polyepoxides to liquid mixtures.

Component (c) is used in such an amount that corresponds to an equivalents ratio of isocyanate groups to epoxy groups of 1.2:1 to 500:1, preferably 3:1 to 65:1, especially 3:1 to 30:1, more preferably 3:1 to 15:1.

According to the invention, the proportion by weight of compound (c) having at least two epoxy groups to the total weight of compound (c) having at least two epoxy groups and of compound (b) having at least two isocyanate-reactive hydrogens is preferably 35% to 80% by weight, more preferably 40% to 70% by weight and especially 45% to 60% by weight.

Catalysts (d) strongly accelerate the reaction of compound (b) having at least two isocyanate-reactive hydrogens and of compound (c) having epoxy groups with the polyisocyanates (a).

Catalysts (d) preferably include at least one incorporable catalyst. Incorporable catalysts (d1) have at least one, preferably 1 to 8 and more preferably 1 to 2 isocyanate-reactive groups, such as primary amine groups, secondary amine groups, hydroxyl groups or urea groups. In the present invention, incorporable catalysts having at least one tertiary amine group are considered not to be compounds (b) having at least two isocyanate-reactive hydrogens but to be catalysts (d). A distinction is made here between amides and amine groups; primary and secondary amides are not referred to as primary and secondary amine groups in the context of this invention. The incorporable amine catalysts preferably have primary amine groups, secondary amine groups and/or hydroxyl groups. According to the invention, the incorporable amine catalysts have at least one tertiary amino group as well as the isocyanate-reactive group(s). At least one of the tertiary amino groups in the incorporable catalysts preferably bears at least two aliphatic hydrocarbon radicals, preferably having 1 to 10 carbon atoms per radical, particularly preferably having 1 to 6 carbon atoms per radical. The tertiary amino groups more preferably bear two radicals selected independently from methyl and ethyl radicals and a further organic radical. Examples of usable incorporable catalysts are for example bis(dimethylaminopropyl) urea, bis(N,N-dimethylaminoethoxyethyl) carbamate, dimethylaminopropylurea, N,N,N-trimethyl-N-hydroxyethylbis(aminopropyl) ether, N, N, N-trimethyl-N-hydroxyethylbis(aminoethyl) ether, diethylethanolamine, bis(N,N-dimethyl-3-aminopropyl)amine, dimethylaminopropylamine, 3-dimethylaminopropyl-N,N-dimethylpropane-1,3-diamine, dimethyl-2-(2-aminoethoxyethanol) and 1,3-bis(dimethylamino) propan-2-ol, N,N-bis(3-dimethylaminopropyl)-N-isopropanolamine, bis(dimethylaminopropyl)-2-hydroxyethylamine, N,N,N-trimethyl-N-(3-aminopropyl)bis(aminoethyl) ether, 3-dimethylaminoisopropyldiisopropanolamine, and mixtures thereof.

As well as the incorporable amine catalysts, it is also possible to use further customary amine catalysts (d2) as also known for production of polyurethanes. Examples include amidines, such as 2,3-dimethyl-3,4,5,6-tetrahydropyrimidine, tertiary amines, such as triethylamine, dimethylcyclohexylamine, dimethyloctylamine, N,N-tributylamine, triethylenediamine, dimethylbenzylamine, N-methyl-, N-ethyl-, and N-cyclohexylmorpholine, N,N,N′,N′-tetramethylethylenediamine, N,N, N′,N′-tetramethylbutanediamine, N, N, N′,N′-tetramethylhexanediamine, pentamethyldiethylenetriamine, tetramethyldiaminoethyl ether, bis(N,N-dimethylaminopropyl) ether, bis(dimethylaminopropyl) urea, dimethylpiperazine, 1,2-dimethylimidazole, 1-azabicyclo(3.3.0) octane, and preferably 1,4-diazabicyclo(2.2.2) octane. Also suitable are, for example, pentamethyldiethylenetriamine, N-methyl-N′-dimethylaminoethylpiperazine, N,N-diethylethanolamine and silamorpholine, boron trichloride tert-amine adducts, and N-[3-(dimethylamino) propyl]formamide.

If further catalysts are used as well as incorporable catalysts, these preferably comprise boron trichloride tert-amine adducts, N,N-dimethylbenzylamine and/or N,N-dibenzylmethylamine and/or boron trichloride-N, N-dimethyloctylamine.

Catalysts (d) are preferably used in a concentration of 0.001% to 8% by weight, more preferably 0.6% to 6% by weight, further preferably 1.5% to 5% by weight and especially 2.1% to 5% by weight as catalyst or catalyst combination, based on the total weight of components (a), (b), (c) and (d). The proportion of catalyst having groups reactive toward isocyanates is at least 5% by weight, more preferably at least 8% by weight and especially 8% to 25% by weight, based on the total weight of the catalyst (d).

The chemical and/or physical blowing agents (e) that are used for production of the foams of the invention comprise formic acid, optionally in a mixture with other blowing agents. In addition to formic acid, with or without water, phospholine oxide is a possible chemical blowing agent. These chemical blowing agents react with isocyanate groups to form carbon dioxide, and in the case of formic acid to give carbon dioxide and carbon monoxide. These blowing agents are referred to as chemical blowing agents because they liberate the gas through a chemical reaction with the isocyanate groups. In addition, it is possible to use physical blowing agents such as low-boiling hydrocarbons. Suitable physical blowing agents are in particular liquids that are inert toward the polyisocyanates a) and have boiling points below 100° C., preferably below 50° C., at atmospheric pressure, and which therefore evaporate under the influence of the exothermic polyaddition reaction. Examples of such liquids that are used with preference are alkanes such as heptane, hexane, n- and isopentane, preferably technical grade mixtures of n- and isopentanes, n- and isobutane and propane, cycloalkanes such as cyclopentane and/or cyclohexane, ethers such as furan, dimethyl ether and diethyl ether, ketones such as acetone and methyl ethyl ketone, alkyl carboxylates such as methyl formate, dimethyl oxalate and ethyl acetate, and halogenated hydrocarbons such as methylene chloride, dichloromonofluoromethane, difluoromethane, trifluoromethane, difluoroethane, tetrafluoroethane, chlorodifluoroethanes, 1,1-dichloro-2,2,2-trifluoroethane, 2,2-dichloro-2-fluoroethane, pentafluoropropane, heptafluoropropane and hexafluorobutene. It is also possible to use mixtures of these low-boiling-point liquids with one another and/or with other substituted or unsubstituted hydrocarbons. Examples of further suitable compounds are organic carboxylic acids such as formic acid, acetic acid, oxalic acid, ricinoleic acid and compounds containing carboxyl groups. The physical blowing agents are preferably soluble in component (b).

Preferably less than 2% by weight, particularly preferably less than 1% by weight, more preferably less than 0.5% by weight, of halogenated hydrocarbons, and especially none, are used as blowing agent (e). The proportions by weight are based here in each case on the total weight of components (a) to (f). Chemical blowing agents used are preferably water, formic acid/water mixtures or formic acid; particularly preferred chemical blowing agents are formic acid/water mixtures or formic acid. Physical blowing agents used are preferably pentane isomers, or mixtures of pentane isomers.

The chemical blowing agents can be used alone, i.e. without addition of physical blowing agents, or together with physical blowing agents. The chemical blowing agents are preferably used alone. If chemical blowing agents are used together with physical blowing agents, preference is given to using pure water, formic acid/water mixtures or pure formic acid together with pentane isomers or mixtures of pentane isomers. In a particularly preferred embodiment, formic acid is the sole blowing agent.

Auxiliaries and additives (e) used may be, for example, fillers, for example ground quartz, chalk, Microdol, aluminum oxide, silicon carbide, graphite or corundum; pigments, for example titanium dioxide, iron oxide, organic pigments such as phthalocyanine pigments; plasticizers, for example dioctyl phthalate, tributyl phosphate or triphenyl phosphate; incorporable compatibilizers such as methacrylic acid, β-hydroxypropyl ester, maleic esters and fumaric esters; flame retardancy-improving substances such as red phosphorus or magnesium oxide; soluble dyes or reinforcing materials, for example glass fibres or glass weave. Likewise suitable are carbon fibres or carbon fibre weave and other organic polymer fibers, for example aramid fibers or LC polymer fibres (LC=liquid-crystal). Further useful fillers are metallic fillers, such as aluminum, copper, iron and/or steel. The metallic fillers are particularly used in grainy form and/or powder form.

Further auxiliaries and additives (e) that can optionally be included are polymerizable, olefinically unsaturated monomers that can be used in amounts of up to 100% by weight, preferably up to 50% by weight, especially up to 30% by weight, based on the total weight of components a), b) and c).

Typical examples of added polymerizable, olefinically unsaturated monomers are those that do not have any hydrogen atoms reactive toward NCO groups, for example diisobutylene, styrene, C₁-C₄-alkylstyrenes, such as α-methylstyrene, α-butylstyrene, vinyl chloride, vinyl acetate, maleimide derivatives, for example bis(4-maleimidophenyl) methane, C₁-C₈-alkyl acrylates such as methyl acrylate, butyl acrylate or octyl acrylate, the corresponding methacrylic esters, acrylonitrile or diallyl phthalate, and olefinically unsaturated monomers having hydrogen atoms reactive toward NCO groups, for example hydroxyethyl methacrylate, hydroxypropyl methacrylate and aminoethyl methacrylate. In the context of the present invention, olefinically unsaturated monomers having hydrogen atoms reactive toward NCO groups are not considered to be compounds (b).

Any desired mixtures of such olefinically unsaturated monomers may likewise be used. Preference is given to using styrene and/or C₁-C₄-alkyl (meth)acrylates, if the olefinically unsaturated monomers are being used at all. When olefinically unsaturated monomers are included, it is possible, but generally not obligatory, to include conventional polymerization initiators, for example benzoyl peroxide.

The auxiliaries and additives e) may additionally comprise known foam stabilizers of the polyethersiloxane type, mold release agents, e.g. polyamide waxes and/or stearic acid derivatives, and/or natural waxes, e.g. carnauba wax.

The auxiliaries and additives e) may either be incorporated into the starting materials a) and b) prior to the performance of the process of the invention or mixed in only later.

For performance of the process of the invention, the starting materials a), b) and c) may be mixed with one another. Further auxiliaries and additives e), the catalyst c) and blowing agents (d) are optionally added to the reaction mixture, the whole mixture is mixed intimately, and the foamable mixture is poured into an open or closed mold. Alternatively, it is possible to proceed by the two-component method in which an isocyanate component (B) comprising polyisocyanates (a) is mixed with an isocyanate-reactive component (A) comprising compounds (b) and (c). The further components (d) to (f) may be added to one of the components, preferably the isocyanate-reactive component (A).

When a multicomponent mixing head known from polyurethane processing is used, the process is notable for high flexibility. By varying the mixing ratio of components (a), (b) and (c), it is possible to produce different foam qualities with one and the same starting materials. In addition, it is also possible to run different components a) and different components b) directly into the mixing head in different ratios. The auxiliaries and additives e), the catalyst c) and blowing agents d) may be run into the mixing head separately or as a batch. It is also possible to meter in the auxiliaries and additives e) together with the catalyst c) and to meter in the blowing agents d) separately. By varying the amount of blowing agent, it is possible to produce foams with different apparent density ranges.

It is preferable that the components are mixed in one stage (called the “one-shot” method). More preferably, the reaction is to be effected without the step of preliminary trimerization. The production process can be effected continuously or batchwise.

The ratio of isocyanate groups in the compounds of component (a) to isocyanate-reactive groups of component (b) is preferably greater than 1.8:1, particularly preferably 1.8 to 4.0:1, more preferably 2.0 to 3.0:1 and especially 2.0 to 2.5:1.

Depending on the components used, the blowing operation generally commences after a wait time of 2 s to 4 min and is generally complete after 2 min to 8 min. The foams have fine cells and are homogeneous.

The isocyanate-epoxy hybrid foam of the invention preferably has a density of 15 to 60 g/L, more preferably 20 to 40 and especially 25 to 35.

The starting components are preferably mixed at a temperature of 15 to 90° C., more preferably of 20 to 60° C. and especially of 20 to 45° C. The reaction mixture can be poured by means of high- or low-pressure metering machines into closed supported molds. This technology is used to produce, for example, discontinuous sandwich elements.

There is no need for subsequent heat treatment of the foams of the invention. In the preferred embodiment, the foams are not subjected to heat treatment.

When a closed mold is used for production of the foams of the invention (in-mold foaming), it may be advantageous for the purpose of achieving optimal properties to overfill the mold. What is meant by overfilling is to introduce an amount of foamable mixture that would occupy a greater volume than the internal volume of the mold after complete foaming in an open mold.

The rigid foams of the invention are preferably produced on continuously operating double belt systems. In the double belt process, the polyol component and the isocyanate component are preferably metered in by means of a high-pressure machine and mixed in a mixing head. Catalysts and/or blowing agents can be metered into the polyol mixture beforehand by means of separate pumps. The reaction mixture is applied continuously to the lower outer layer. The lower outer layer with the reaction mixture and the upper outer layer run into the double belt, in which the reaction mixture foams and cures. On exiting the double belt, the continuous sheet is cut to the desired dimensions. Sandwich elements having metallic outer layers or insulation elements having flexible outer layers can be produced in this way.

The foams of the invention have low thermal conductivity, very good mechanical properties, such as high compressive strength, and a high compressive modulus of elasticity and low brittleness. Moreover, the foams of the invention are of low flammability and evolve only little heat and smoke when burnt. They have low dielectric losses; moisture resistance and abrasion resistance, and also processibility in molds, are excellent. Therefore, the foams of the invention are of excellent suitability as filling foam for cavities, as filling foam for electrical insulation, as core of sandwich constructions, for production of construction materials for interior and exterior applications of any kind, for production of construction materials for vehicle building, shipbuilding, aircraft building and missile building, for production of aircraft interior and exterior components, for production of insulation materials of any kind, for production of insulation panels, pipe and vessel insulations, for production of sound-absorbing materials, for use in engine spaces, for production of grinding disks and for production of high-temperature installations and low-flammability insulations. Particular preference is given to use as core foam of sandwich elements, giving sandwich elements having a particularly small number of cavities and excellent adhesion between foam layer and outer layer. The present invention thus further provides a sandwich element comprising an isocyanate-epoxy hybrid foam of the invention.

The present invention will be illustrated below with the aid of examples:

### EXAMPLES

For production of a laboratory form, according to table 1 (figures in parts by weight), for a given isocyanate index, the feedstocks of the A component are added to one another in the sequence that follows. The epoxy resin, polyol and water were mixed. Then the catalyst mixture was added and stirred in. Finally, the chemical blowing agent and the physical blowing agent were added to the component.

The A component was mixed vigorously with the specified amount of isocyanate component using a laboratory stirrer (Vollrath stirrer) at a stirrer speed of 1850 rpm and a stirring time of 3 seconds in a beaker, and induced to foam therein. In this “beaker test”, starting time, fiber time and rise time, apparent density and, optionally, brittleness are determined. For the determination of further properties, 2.5 L buckets in each case were produced with a starting weight of 150 g.

The foams were produced using the following feedstocks:
Polyesterol 1: polyester based on terephthalic acid, diethylene glycol, oleic acid and a polyetherol based on glycerol and ethylene oxide, having an OH number of 242 mg KOH/g
Polyesterol 2: polyester based on adipic acid, isophthalic acid, butane-1,4-diol and monoethylene glycol, having an OH number of 55 mg KOH/g
Polyetherol: ethylenediamine-started polyether polyol based on ethylene oxide and propylene oxide, having an OH number of 60 mg KOH/g.
TEP: triethyl phosphate
TCPP: tris(2-chloroisopropyl) phosphate
Epoxide 1: Leuna, Epilox® A 18-00, low molecular weight epoxy resin based on bisphenol A, commercial product from LEUNA-Harze GmbH, Leuna, Germany, epoxy equivalent of 178-185 g/eq to DIN 16945, viscosity at 25° C. 8000 to 10 000 mPas to DIN 53015.
Stabilizer: Tegostab® B 8498 silicone stabilizer, polyetherpolysiloxane, commercial product from Evonik, Essen, Germany.
Formic acid: 85% by weight formic acid in water
Catalyst: catalyst mixture of diethyltoluenediamine, N,N,N′-trimethylaminoethylethanolamine, triethylenediamine and bis(2-dimethylaminoethyl)methylamine
Additive 1: a mixture of water, dipropylene glycol and glycerol, having an OHN of 425 mg/KOH g
Isocyanate: polymeric methylene diphenyl diisocyanate (PMDI), having a viscosity of about 500 mPa*s at 25° C.

### Determination of Apparent Density by Manual Experiment (Beaker Test):

The apparent density of the foam is determined in the beaker test by separating off the foam above the edge of the beaker and then weighing the beaker together with the remaining foam. This mass, minus the mass of the empty beaker (measured before foaming), divided by the volume of the beaker (0.735 L), gives the apparent density.

### Machine Samples:

100 mm-thick sandwich elements were produced by the double belt process. The liquid apparent density was adjusted to 33±1 g/L by means of the catalyst mixture.

The following measurements were conducted on the machine-made foams:

### Determination of Brittleness of the Rigid Foams:

The brittleness of the laboratory foams was ascertained to ASTM C421 (08) 2014. For this purpose, twenty-four room-dried cubes of oak (19 mm) were first placed into a cubic oakwood box (190×197×197 mm). The foam is cut into 12 small cubes (2.5 mm) with the aid of a fine-tooth saw. These specimens are weighed with a precision balance (M1) and placed into the test apparatus together with the oak cubes. The box is mounted rigidly in the middle such that the axis normal to one face of the box is that of a rotatable shaft. The box rotates at 60±2 revolutions per minute for 600±3 revolutions. After the defined test phase, the twelve pieces of foam are removed cautiously from the box. The samples are removed from residues of dust and particles and then weighed again (M2). The loss of mass is calculated by the following equations:

Loss of mass (%)=[(M₁−M₂)/M₁]*100
M1=original mass M2=final mass

### Tensile Strength

Tensile strength testing was conducted in accordance with DIN EN ISO 14509-1/EN 1607

### Thermal Conductivity:

After the foaming, a foam cuboid is stored under standard climatic conditions for 24 hours. The test specimen is then cut out of the middle of the foam cuboid (i.e. the top side and bottom side are removed) and has dimensions of 200×200×30 mm. Thermal conductivity is then determined using a Hesto A50 heat flow measurement plate device at a middle temperature of 10° C.

### Determination of Compressive Strength:

Compressive strength is determined in accordance with DIN 53421/DIN EN ISO 604.

### Small Burner Test (Euro Class E):

The fire test was conducted in accordance with EN-ISO 11925-2; the figure corresponds to the flame height in cm.

| | Comp. | Comp. | Comp. | Comp. | EX. | EX. | EX. | EX. | EX. | EX. |
|---|---|---|---|---|---|---|---|---|---|---|
| | 1 | 2 | 3 | 4 | 1 | 2 | 3 | 4 | 5 | 6 |
| Polyesterol 1 | 35.2 | 35.2 | 35.2 | 35.2 | 35.2 | 35.2 | 32 | 32 | 33 | 34 |
| TEP | 11.7 | 11.7 | 11.7 | 11.7 | 11.7 | 11.7 | 5.3 | 10.61 | 5.3 | 5.3 |
| TCPP | | | | | | | 5.3 | 5.3 | 6.3 | 7.3 |
| Water | 1.9 | 1.9 | 1.9 | 1.9 | 1.9 | 1.9 | 3 | 1.4 | 1.4 | 1.8 |
| Epoxide | 48 | 48 | 48 | 48 | 48 | 48 | 43.8 | 43.8 | 43.8 | 43.8 |
| Stabilizer | 3.2 | 3.2 | 3.2 | 3.2 | 3.2 | 3.2 | 2.9 | 2.9 | 2.9 | 2.9 |
| Formic acid | 3.8 | 3.8 | 3.8 | 3.8 | 3.8 | 3.8 | 3.7 | 1.8 | 1.8 | 1.9 |
| Catalyst | 10.2 | 10.8 | 11 | 12.9 | 11 | 13 | 11.1 | 10.1 | 8.7 | 8.6 |
| Glycerol | | | 2.3 | 2.3 | | | | | | |
| Polyetherol | | | | | 11.7 | 11.7 | 10.7 | 10.7 | | |
| Polyesterol 2 | | | | | | | | | 10.7 | 10.7 |
| Pentane | 7.8 | 8.9 | 9.4 | 11.1 | 9.2 | 11.4 | 6.4 | 15 | 14.5 | 14 |
| Isocyanate | 277.4 | 303.4 | 299.4 | 327.4 | 281 | 308 | 270.8 | 206.7 | 203.3 | 212.7 |
| Index | 210 | 230 | 210 | 230 | 210 | 230 | 220 | 220 | 220 | 220 |
| Measurements | | | | | | | | | | |
| Core density | 30.43 | 30.57 | 28.77 | 29.83 | 30.23 | 31.27 | 29.9 | 29.47 | 29.43 | 29.37 |
| [g/L] | | | | | | | | | | |
| Compressive | 0.182 | 0.15 | 0.136 | 0.147 | 0.146 | 0.169 | 0.193 | 0.143 | 0.141 | 0.135 |
| strength [N/mm²] | | | | | | | | | | |
| Tensile strength | 0.07 | 0.06 | | 0.07 | 0.09 | 0.1 | 0.07 | 0.1 | 0.06 | 0.08 |
| [N/mm²] | | | | | | | | | | |
| Thermal | 24.8 | 22.9 | 21.9 | 22.3 | 22.2 | 22.8 | 23.5 | 22.4 | 21.8 | 21.9 |
| conductivity | | | | | | | | | | |
| [mW/mK] | | | | | | | | | | |
| Small burner test | 7 | 8 | 8.3 | 9 | 9.3 | 9 | 8.3 | 12 | 9 | 10 |
| [cm] | | | | | | | | | | |

Table 1 shows that, in the case of the inventive combination of polyester with an OH number of 195 to 400 mg KOH/g and a functionality of 2 to 4 and polyether with an OH number of 40 to 80 mg KOH/g and a functionality of 2.6 to 6.5, with comparable density and comparable index, foams having improved tensile strength and reduced thermal conductivity are obtained.

### Example 2

By the foaming method described in example 1, foams were produced with a varying amount of polyesterol 1. In order to determine brittleness, 2.5 L buckets with a density of 35±1 g/L were produced by the method described above. The exact composition of the starting substances and the mechanical values and results of the brittleness measurement are reported in table 2.

### Table 2:

Components in foam formulation and physical parameters.

| Formulation | 2.1 | 2.2 | 2.3 | 2.4 | 2.5 | 2.6 | 2.7 |
|---|---|---|---|---|---|---|---|
| Epoxide | 71.00 | 61.00 | 51.00 | 41.00 | 31.00 | 21.00 | 11.00 |
| Additive 1 | 2.20 | 2.00 | 2.00 | 2.00 | 2.00 | 2.00 | 2.00 |
| Polyesterol 1 | — | 10.00 | 20.00 | 30.00 | 40.00 | 50.00 | 60.00 |
| Stabilizer | 2.70 | 2.70 | 2.70 | 2.70 | 2.70 | 2.70 | 2.70 |
| Amasil 85% | 2.00 | 2.00 | 2.00 | 2.00 | 2.00 | 2.00 | 2.00 |
| Polyetherol | 10.00 | 10.00 | 10.00 | 10.00 | 10.00 | 10.00 | 10.00 |
| TCPP | 5.00 | 5.00 | 5.00 | 5.00 | 5.00 | 5.00 | 5.00 |
| TEP | 5.00 | 5.00 | 6.00 | 5.00 | 5.00 | 5.00 | 5.00 |
| Catalyst | 9.5 | 9.5 | 9.5 | 9.5 | 9.5 | 9.5 | 9.5 |
| Pentane | 10.00 | 10.00 | 10.00 | 10.00 | 10.00 | 10.00 | 10.00 |
| Isocyanate | 191.3 | 187.7 | 184.1 | 180.6 | 177.0 | 173.4 | 169.9 |
| Index | 220 | 220 | 220 | 220 | 220 | 220 | 220 |
| Measurements | | | | | | | |
| Density (core) [g/L] | 35.0 | 35.0 | 34.0 | 32.5 | 32.5 | 32.9 | 32.2 |
| Compressive strength | 0.196 | 0.197 | 0.2 | 0.199 | 0.179 | 0.179 | 0.167 |
| [N/mm²] | | | | | | | |
| Brittleness test | | | | | | | |
| Loss of cuboid mass | 44 | 33 | 29 | 28 | 21 | 8 | 15 |
| [%] | | | | | | | |

The examples in table 2 show that the use of polyesterol and polyetherol can drastically reduce brittleness. The lowest loss of mass and hence the lowest brittleness are exhibited by the foam having a proportion by mass of 11 wt % of epoxide. The reduction in the epoxide component reduces brittleness, but at same time also reduces compressive strength. The optimum of high compressive strength and reduced brittleness is at 41 parts epoxide and 30 parts polyesterol in the A component.

1. A process for producing an isocyanate-epoxy hybrid foam having a density of 15 to 60 g/L, in which
a) polyisocyanate is mixed with
b) at least two compounds having at least two isocyanate-reactive hydrogens,
c) at least one compound having at least two epoxy groups and having an epoxy equivalent weight of 90 to 500 g/eq,
d) at least one catalyst that accelerates the reaction of compound (b) having at least two isocyanate-reactive hydrogens and of compound (c) having epoxy groups with the polyisocyanates (a),
e) chemical and/or physical blowing agents, comprising formic acid, and
f) optionally auxiliaries and additives,
to give a reaction mixture, where the equivalents ratio of isocyanate groups in the polyisocyanate (a) to epoxy groups in the compound (c) having at least two epoxy groups is 1.2:1 to 500:1, and the reaction mixture is converted to the isocyanate-epoxy hybrid foam, wherein the compound (b) having at least two isocyanate-reactive hydrogen atoms includes at least one polyesterol (b1) having a hydroxyl number of 195 to 400 mg KOH/g and an average nominal functionality of 2 to 4 and at least one polyether polyol (b2) having a hydroxyl number of 40 to 80 mg KOH/g and an average nominal functionality of 2.6 to 6.5.

2. The process according to claim 1, wherein polyester polyol (b1) is preparable by condensation of an at least difunctional acid component with an at least difunctional alcohol component, and the acid component comprises an at least difunctional aromatic acid or the derivative of an aromatic dicarboxylic acid.

3. The process according to claim 2, wherein the proportion of the at least difunctional aromatic acid is at least 20% by weight, based on the total weight of the acid component and the alcohol component.

4. The process according to any of claim 1, wherein the polyetherol (b2) comprises at least one amine-started polyether polyol.

5. The process according to any of claim 1, wherein the proportion by weight of the polyesterol (b1) in the total weight of polyesterol (b1) and polyetherol (b2) is 40% to 80% by weight.

6. The process according to any of claim 1, wherein the proportion by weight of compound (c) having at least two epoxy groups to the total weight of compound and compound (b) having at least two isocyanate-reactive hydrogens is 35% to 80% by weight.

7. The process according to any of claim 1, wherein the isocyanates a) comprise mixtures of at least one oligomer of MDI and at least one of the low molecular weight MDI derivatives 2,2′-MDI, 2,4′-MDI and 4,4′-MDI.

8. The process according to claim 7, wherein the content of oligomeric MDI is greater than 30% by weight to less than 80% by weight, based on the total weight of component (a).

9. The process according to any of claim 1, wherein compound (c) having at least two epoxy groups is selected from the group consisting of polyglycidyl ether of bisphenol A, bisphenol F or novolaks.

10. The process according to any of claim 1, wherein the catalyst (d) that accelerates the isocyanate/epoxide reaction includes at least one catalyst (d1) having at least one isocyanate-reactive hydrogen atom.

11. The process according to any of claim 1, wherein the ratio of isocyanate groups in the compounds of component (a) to isocyanate-reactive groups of component (b) is greater than 1.8:1.

12. The process according to any of claim 1, wherein the reaction mixture is applied to a lower outer layer and a composite element is produced continuously by the double belt method.

13. An isocyanate-epoxy hybrid foam obtainable according to claim 1.

14. A sandwich element comprising an isocyanate-epoxy hybrid foam according to claim 13.
